(19) United States
(12) Patent Application Publication
(10) Pub. No.: US 2024/0370638 A1
(43) Pub. Date: Nov. 7, 2024

(54) Systems and Methods for Optimizing Content Linking Between Applications

(71) Applicant: Google LLC, Mountain View, CA (US)

(72) Inventors: Irina Blok, San Francisco, CA (US); Robert Corneliu Benea, San Jose, CA (US)

(21) Appl. No.: 18/253,869

(22) PCT Filed: May 27, 2022
(86) PCT No.: PCT/US2022/031385

§ 371 Date: May 22, 2023

(51) Int. Cl. G06F 40/134; G06F 3/0482; G06F 3/0484; G06F 9/451; G06F 40/169

(52) U.S. Cl. CPC G06F 40/134; G06F 3/0482; G06F 3/0484; G06F 9/451; G06F 40/169

(57) ABSTRACT

Systems and methods of the present disclosure are directed to a method for optimizing interface efficiency. The method includes determining a persistent insertion point within an input field of a first application. The method includes receiving a first input from a user that selects linkable entity(s) of an interface of a second application. The first input is indicative of an instruction to provide an action menu associated with the linkable entity(s). The method includes providing an action menu including a selectable action element corresponding to an action and that is descriptive of an action to add a link to the first application to the linkable entity(s). The method includes, responsive to a second input that selects the selectable action element, generating a linking element for the linkable entity(s). The linking element is located at the persistent insertion point.

### FIELD

The present disclosure relates generally to optimizing linking of content between applications. More particularly, the present disclosure relates to maintaining persistent insertion points within applications for linking of content accessed in different applications.

### BACKGROUND

Creating content, such as research papers, studies, or articles, often necessitates creation of bibliographic material. However, creation of this bibliographic material conventionally necessitates an onerous process in which a user navigates between applications multiple times to transfer information.

As an example, for a user to conventionally create bibliographic material, the user must navigate from a content creation application (e.g., a text editor, video editor, etc.) to a second application (e.g., a search engine) that can locate linkable entities for the bibliographic material (e.g., relevant internet sources, etc.). Next, the user copies information describing the linkable entities (e.g., web addresses, etc.) and then must return to the content creation application to create the bibliographic material using the copied information. As such, systems and methods that optimize the process of linking content between applications are desired.

### SUMMARY

Aspects and advantages of embodiments of the present disclosure will be set forth in part in the following description, or can be learned from the description, or can be learned through practice of the embodiments.

One example aspect of the present disclosure is directed to computer-implemented method for optimizing interface efficiency via persistence across applications. The method includes determining a persistent insertion point within an input field of a first application. The method includes receiving a first input from a user that selects at least one linkable entity of one or more linkable entities of an interface of a second application, wherein the first input is indicative of an instruction to provide an action menu associated with the at least one linkable entity. The method includes providing an action menu comprising a selectable action element corresponding to an action, wherein the selectable action element is descriptive of an action to add a link to the first application that links to the at least one linkable entity. The method includes, responsive to a second input from the user that selects the selectable action element, generating a linking element for the at least one linkable entity, wherein the linking element is located at the persistent insertion point within the input field of the first application.

Another example aspect of the present disclosure is directed to a computing system for optimizing interface efficiency via persistence across applications. The computing system includes one or more processors. The computing system includes one or more non-transitory computer-readable media that store instructions that, when executed by the one or more processors, cause the computing system to perform operations. The operations include determining a persistent insertion point within an input field of a first application. The operations include receiving a first input from a user that selects at least one linkable entity of one or more linkable entities of an interface of a second application, wherein the first input is indicative of an instruction to provide an action menu associated with the at least one linkable entity. The operations include providing an action menu comprising a selectable action element corresponding to an action, wherein the selectable action element is descriptive of an action to add a link to the first application that links to the at least one linkable entity. The operations include, responsive to a second input from the user that selects the selectable action element, generating a linking element for the at least one linkable entity, wherein the linking element is located at the persistent insertion point within the input field of the first application.

Another example aspect of the present disclosure is directed to one or more non-transitory computer-readable media that store instructions that, when executed by one or more processors, cause a computing system to perform operations. The operations include determining a persistent insertion point within an input field of a first application. The operations include receiving a first input from a user that selects at least one linkable entity of one or more linkable entities of an interface of a second application, wherein the first input is indicative of an instruction to provide an action menu associated with the at least one linkable entity. The operations include providing an action menu comprising a selectable action element corresponding to an action, wherein the selectable action element is descriptive of an action to add a link to the first application that links to the at least one linkable entity. The operations include, responsive to a second input from the user that selects the selectable action element, generating a linking element for the at least one linkable entity, wherein the linking element is located at the persistent insertion point within the input field of the first application.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system 100 that performs optimization of interface efficiency via persistence across applications according to example embodiments of the present disclosure.

FIG. 2 depicts interfaces for a first application that include locations of persistent insertion points according to some embodiments of the present disclosure.

FIG. 3 illustrates interfaces of a second application that include linkable entities according to some embodiments of the present disclosure.

FIG. 4 illustrates interfaces and of the second application that include linkable entities according to some other embodiments of the present disclosure.

FIG. 5 illustrates interfaces of the first application that include linking elements for linkable entity(s) according to some embodiments of the present disclosure.

FIG. 6 illustrates interfaces of a first application according to some other embodiments of the present disclosure.

FIG. 7 illustrates interfaces of a second application according to some other embodiments of the present disclosure.

FIG. 8 depicts a flow chart diagram of an example method to perform according to example embodiments of the present disclosure.

Reference numerals that are repeated across plural figures are intended to identify the same features in various implementations.

### DETAILED DESCRIPTION

### Overview

Generally, the present disclosure is directed to optimizing linking of content between applications. More particularly, the present disclosure relates to maintaining persistent insertion points within applications for linking of content accessed in different applications. As an example, a user can enter content into an input field of a content creation application (e.g., a text input box of a browser-based word editor). After textual content has been entered, a persistent insertion point can be determined within the input field (e.g., the last place the cursor was located within the field, a portion of textual content highlighted by the user, etc.). The user may then provide an input that selects linkable entity(s) within an interface of a second application. For example, the user may navigate away from a word editor application to a search engine application to enter a query relevant to the content of the input field (e.g. a query for references for a document, etc.). The search engine may retrieve linkable entities (e.g., search results) in response to the query and provide them to the user within its interface. The first input from the user can select one or more of these linkable entities (e.g., a touch-and-hold input to a touchscreen, etc.).

Once selected, an action menu can be provided to the user that includes a selectable action element that corresponds to an action (e.g., a pop-up menu, etc.). Specifically, the selectable action element can describe an action to add a link to the first application that links to the linkable entity(s) selected by the user. The user can select the selectable action element, and a linking element for the linkable entity(s) (e.g., a hyperlink, bibliographic material descriptive of the linkable entity(s), etc.) can be generated at the persistent insertion point within the input field of the first application. To follow the previous example, a hyperlink to the linkable entity(s) may be generated at the location of the persistent insertion point. In such fashion, rather than being forced to navigate back and forth between applications, a user can quickly and efficiently locate a linkable entity and create a linking element within a separate application without any additional navigation.

Embodiments of the present disclosure provide a number of technical effects and benefits. As one example technical effect and benefit, by reducing the number of navigational actions required by a user, systems and methods of the present disclosure substantially reduce resource consumption associated with such navigational actions (e.g., memory, power, storage, compute cycles, etc.). As another example technical effect and benefit, embodiments of the present disclosure substantially increase user efficiency by eliminating required navigational actions, and as such, provide a technical contribution towards content creation workflows. As another example technical effect and benefit, embodiments of the present disclosure assist the user in performing a technical task by means of a continued and/or guided human-machine interaction process, not least by reducing the number of interactions from a user to link content between documents. As another example technical effect and benefit, as compared to, for instance, copying and pasting a hyperlink to a linkable entity via a clipboard, embodiments of the present disclosure are transparent for the user linking content between documents, and may not interfere with content stored in the clipboard when doing so.

With reference now to the Figures, example embodiments of the present disclosure will be discussed in further detail.

### Example Devices and Systems

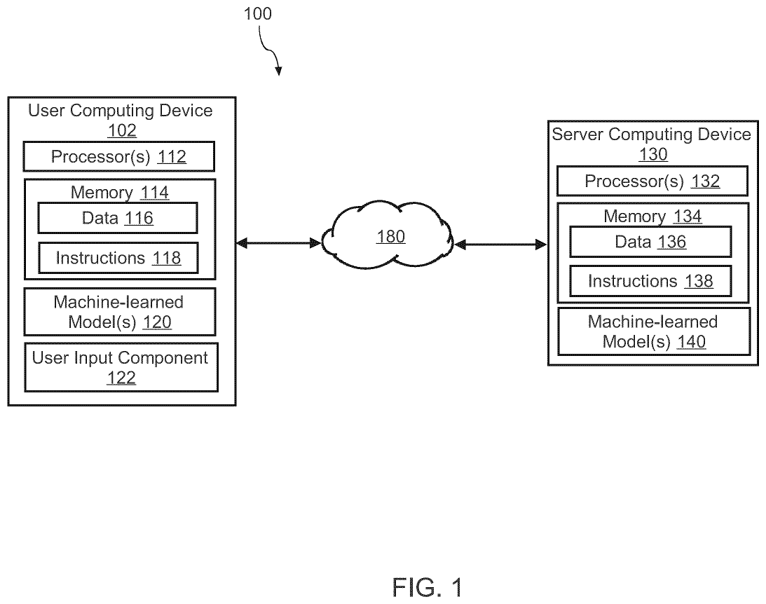

FIG. 1 depicts a block diagram of an example computing system 100 that performs optimization of interface efficiency via persistence across applications according to example embodiments of the present disclosure. The system 100 includes a user computing device 102, and a server computing system 130.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120.

In some embodiments, the models 120 may be utilized to determine a persistent insertion point within an input field, or to determine the application in which a user wishes to generate a linking element. For example, a user may navigate through a number of applications executed within various tabs of a web browser application executed on the user computing device 102. The machine learned model 120 may process inputs to generate an output that indicates which of these applications should include a persistent insertion point. For example, the machine learned model may process data descriptive of user contextual history, prior actions of the user and/or other users, content entered by the user into the applications or otherwise presented by the applications, etc. As such, it should be broadly understood that the machine-learned models 120 may be trained using any type of data associated with the user, other users, and/or the applications that the user is navigating between.

To follow the previous example, the user may navigate between a search engine application, a word editor application, and a photo editing application. The model 120 may process data indicative of textual content entered into the word editor application to generate an output indicating that the user desires to generate a linking element within an input field of the word editor application. Based on this output, the persistent insertion point can be determined within the input field of the word editor application.

Additionally or alternatively, one or more models 140 can be included in or otherwise stored and implemented by the server computing system 130 that communicates with the user computing device 102 according to a client-server relationship. For example, the models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1 illustrates one example computing system that can be used to implement the present disclosure. Other computing systems can be used as well. For example, in some implementations, the user computing device 102 can include a model trainer and associated training dataset. In such implementations, the models 120 can be both trained and used locally at the user computing device 102. In some of such implementations, the user computing device 102 can implement a model trainer to personalize the models 120 based on user-specific data.

### Example Interface Arrangements

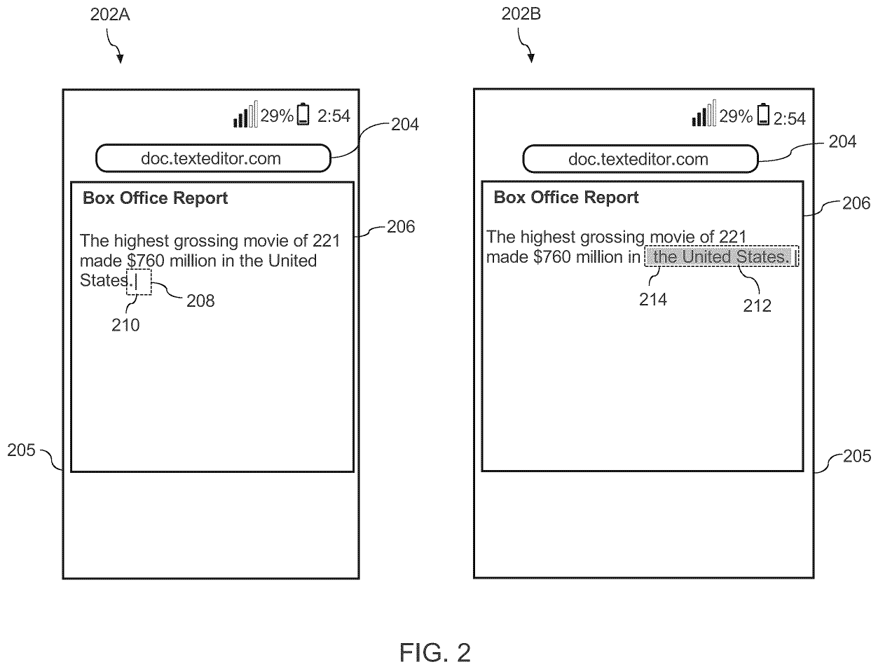

FIG. 2 depicts interfaces 202A and 202B for a first application 204 that include locations of persistent insertion points 210 and 214 according to some embodiments of the present disclosure. Specifically, interface 202A illustrates an interface of an application 204 executed by a user device 205 (e.g., a smartphone, etc.) in which a user is utilizing a browser-based word editing application 204. As depicted, the user has input textual content to an input field 206 (e.g., a textual input field) of the word editing application 204. The input element 208 (e.g., a cursor) indicates a last location in which the user last input textual content to the input field 206.

A persistent insertion point 210 can be determined within the input field 206 of the application 204. The persistent insertion point 210 can point to a location within an input field, and can persist across applications. Specifically, the persistent insertion point 210 can be utilized after a user has navigated from a first application to a second application. As an example, an operating system of the device 205 that executes the application 204 (e.g., user computing device 102 of FIG. 1), may determine the persistent insertion point 210 so that the persistent insertion point 210 can be utilized when the user has navigated to an application different than the application 204. As another example, the persistent insertion point 210 may be provided to a cloud system associated with the application 204, and/or a second application that the user navigates to. Specifically, if both the first and second application are provided by a service provider (e.g., a provider of a browser-based software suite, etc.), the persistent insertion point 210 may be provided to a remote server of the service provider by the user computing device 205 executing the application 204. Once the user navigates to a second application provided by the service provider, the persistent insertion point 210 may be provided to the user computing device 205 by the remote server of the service provider.

In some embodiments, the persistent insertion point 210 can be, or otherwise indicate, a last location of the input element 208 within the input field 206 of the first application 204. For example, as depicted in interface 202A, the persistent insertion point 210 can be, or otherwise indicate, the last location of the input cursor 208 within the textual input field 206. As such, in some instances, the persistent insertion point may be referred to as a selected cursor location within the first application.

Alternatively, it some embodiments, the persistent insertion point may be located at a selected portion of the input field that has been selected or otherwise indicated by the user. For example, interface 202B includes the application 204 and textual input field of interface 202A. However, interface 202B further depicts a portion 212 of the input field (e.g., content within the input field) that has been selected or otherwise indicated by a user. For example, the user may select a portion of textual content 212 that the user previously input using a highlight function of the operating system of the device 205 executing application 204. The persistent insertion point 214 can be determined at the location of the selected portion of the textual content 212 within the input field 204. The user may then navigate to a second application to perform research corresponding to the portion of selected textual content.

It should be noted that although embodiments of the present disclosure are illustrated as browser-based applications executed on a smartphone device, they are not limited to such use-cases. Rather, the first and second applications of the present disclosure may be any type of application executed using a computing device. For example, the first application may be a word editing application stored and executed on a laptop computing device, and the second application may be a browser-based search engine running within a browser application stored and executed by the laptop computing device. Alternatively, the first and second applications of the present disclosure may run in two respective tabs of a web browser stored and executed on a user computing device (e.g., a smartphone device, a wearable computing device, an augmented reality (AR) computing device, etc.).

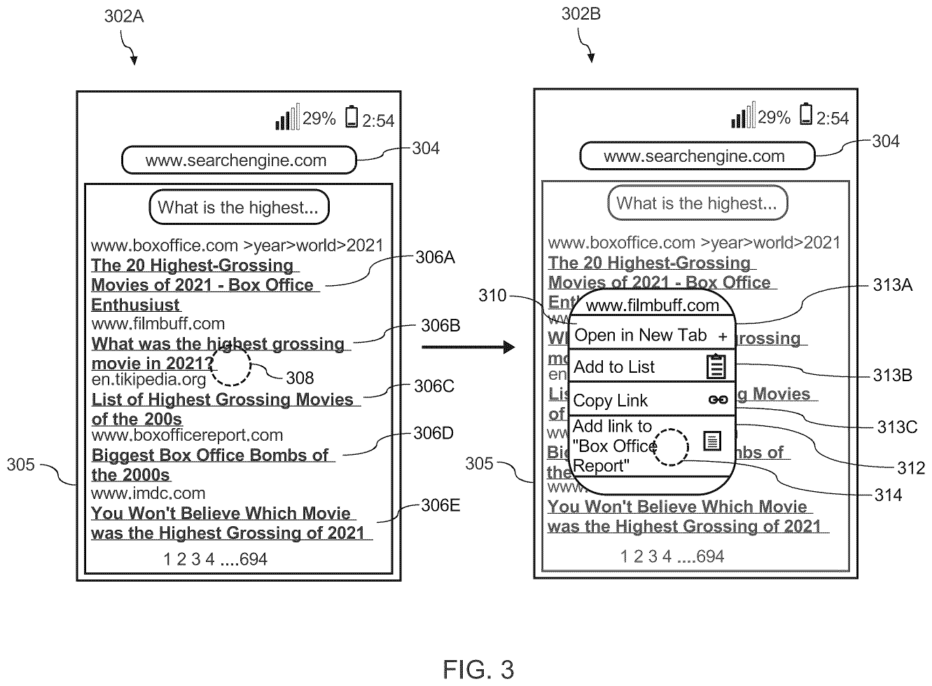

FIG. 3 illustrates interfaces 302A and 302B of a second application 304 that include linkable entities 308 according to some embodiments of the present disclosure. The second application 304 can be executed concurrently with first application 204 of FIG. 2 by the user computing device 205 of FIG. 2. In some embodiments, the application 304 may be executed within a second instance or tab of a browser application executed by the user computing device 205, and the first application 204 of FIG. 2 may be executed within a first instance or tab of the browser application.

In some embodiments, a user may navigate from the interface 202 of the first application 204 depicted in FIG. 2 to the interface 302 of the second application 304 via a navigation input. The navigation input can indicate an instruction to navigate from the first application 204 to the second application 304. As an example, the navigation input may be a touch input from a user that selects a different tab of a browser application. As another example, the navigation input may be a vocalized search query to a virtual assistant application. As yet another example, the navigation input may be an image search query to a virtual assistant application.

The interface of the second application 304 may include one or more linkable entities 306. Specifically, in the depicted example of interface 302A, the second application is a search engine application that has retrieved a number of linkable entities 306A-306E (e.g., search results) in response to a query from the user. However, it should be noted that the linkable entities are not limited to results from a search engine application. Rather, the linkable entity(s) 306 can include any entity that can be linked to or otherwise referenced. In some embodiments, a linkable entity(s) 306 may be or otherwise include website or web document. For example, the linkable entity(s) 306 may include a search result retrieved in response to a query that includes a link to a website alongside information descriptive of the website. Additionally, or alternatively, in some embodiments, the linkable entity(s) 306 may include some other form of media or content (e.g., a video, document, book, livestream, recording, etc.). For example, the linkable entity(s) 306 may include an online video uploaded to a video sharing site. For another example, the linkable entity(s) 306 may include an e-book, or a digitized excerpt from a book. For yet another example, the linkable entity(s) 306 may include an image. In some examples, the linkable entities may be retrieved from a plurality of sources, some of which may be particularly relevant to the user (e.g. from the user's history, the user's favorites, etc.).

A first input 308 can be received from the user that selects at least one linkable entity of the linkable entities 306 displayed in the interface 302A. The first input can be an input indicating that an action menu should be provided that corresponds to the selected linkable entity(s). To follow the depicted example, the first input 308 may be a touch input (e.g., a touch-and-hold input) to a touchscreen of the computing device 205 that selects linkable entity 306B. As another example, the first input 308 may be a input selecting linkable entity 308B that is provided by the user via a peripheral input device connected to the computing device 205 executing the second application 304 (e.g., a mouse, a digital pen, an augmented reality device, etc.). As yet another example, the first input 308 may be a vocalized input to a virtual assistant application that indicates a selection of linkable entity 308B.

Once the computing device 205 has received the first input from the user, the computing device 205 can provide an action menu. Example interface 302B illustrates an example action menu 310 provided within, or overlaid upon, the interface of the second application 304. The action menu 310 can include selectable action element 312. Additionally, in some embodiments, the action menu 310 may include selectable action elements in addition to the selectable action element 312 (e.g., selectable action elements 313A-313C).

Specifically, the selectable action element 312 can correspond to, and describe, an action to add a link to the first application 204 of FIG. 2 that links to the at least one linkable entity(s) 306 selected by the user. To follow the depicted example, after the user selects linkable entity 306B, the selectable action element 312 of the action menu 310 can correspond to an action to add a link to the first application that links to the linkable entity 306B. Furthermore, as depicted, the selectable action element 312 can describe or otherwise indicate this action to the user.

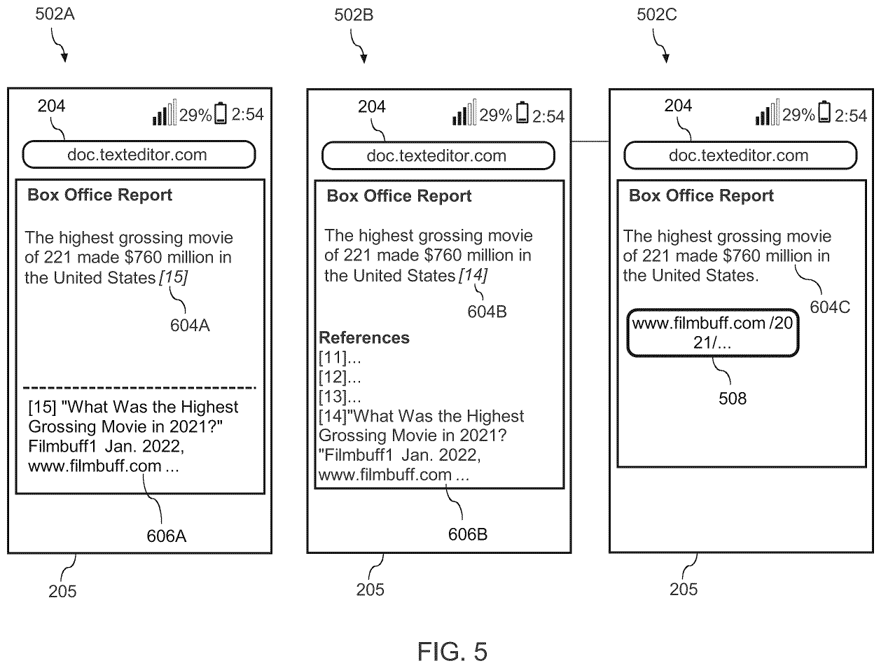

The user can provide a second input 314 that selects the selectable action element 312. The second input 314 can be provided as described with regards to the first input 308. Responsive to the second input, the computing device 205 can generate a linking element for the at least one linkable entity 306B, which will be described in more detail with regards to FIG. 5.

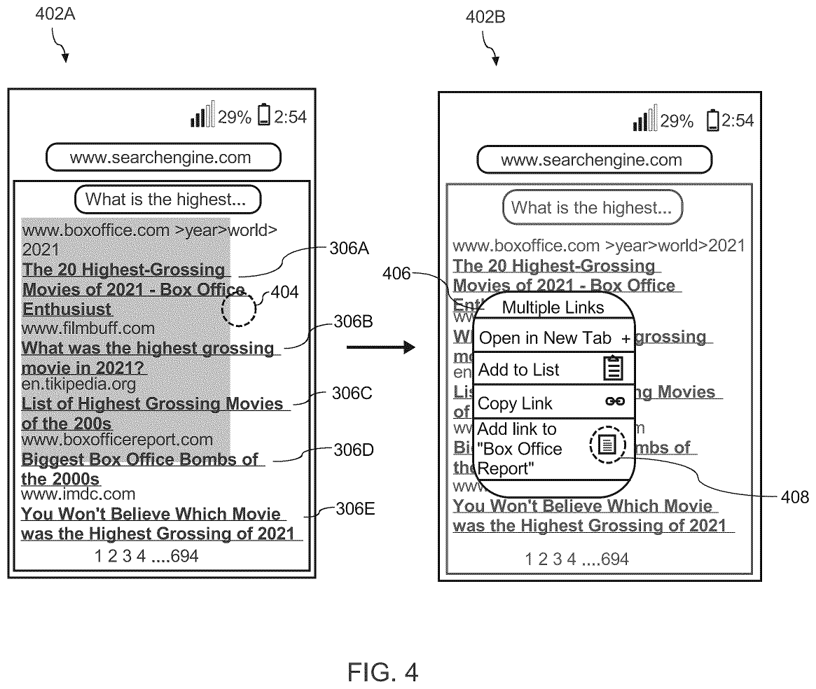

FIG. 4 illustrates interfaces 402A and 402B of the second application 304 that include linkable entities 308 according to some other embodiments of the present disclosure. Specifically, interface 302A of the second application 304 can include the linkable entities 306A-306D as depicted with regards to FIG. 3. However, in some embodiments, a user can select multiple linkable entities 306. In some embodiments, as depicted in interface 402A, the first input 404 may include multiple inputs that both select multiple linkable entities 306 and then indicate to the computing device that an action menu 406 should be provided that corresponds to the multiple selected linkable entities 306. For example, the first input 404 may first select linkable entities 306A-306D (e.g., by highlighting the linkable entities, etc.). The first input 404 may then indicate that the action menu 406 should be provided that corresponds to the selected linkable entities 306A-306D (e.g., right-clicking the highlighted area using a peripheral device connected to a computing device, providing a touch-and-hold input to the highlighted area on a touchscreen of the computing device, etc.).

Example interface 402B illustrates an action menu 406 for the multiple linkable entities 306A-306D selected by the user. As described with regards to FIG. 3, the action menu 406 includes a selectable action element 408 descriptive of an action to add a link to the first application that links to the at least one linkable entities 306A-306D.

FIG. 5 illustrates interfaces 502A-502C of the first application that include linking elements for linkable entity(s) according to some embodiments of the present disclosure. Responsive to the user selecting the selectable action element 314/408 for linkable entity(s) 306A-306E, as illustrated in FIGS. 3 and 4, the computing system 205 can generate a linking element 504 for the at least one linkable entity selected by the user. The linking element 504 can be any interface element or content within the input field of the first application (e.g., a hyperlink, footnote, endnote, parenthetical citation, reference, etc.).

In some embodiments, the linking element 504 can include a reference element indicative of a location of bibliographic information 506 descriptive of the linkable entity. Generating the linking element 504 for the at least one linkable entity can include generating the linking element 504 and the bibliographic information 506 descriptive of the linkable entity. The reference element 504 can be located at the persistent insertion point within the input field, and the bibliographic information 506 can be generated at a location different than the persistent insertion point.

In some embodiments, an interface for the first application can be provided to the user that includes the input field of the first application. Specifically, as depicted in example interface 502A, the linking element 504A may include a reference element 504A (e.g., a footnote element) indicating the location of the bibliographic information 506A that is descriptive of the linkable entity. To follow the depicted example of interface 502A, the footnote element 504A can indicate that the bibliographic information 506A is located at footnote 15.

Additionally, or alternatively, in some embodiments, the linking element 504 may be an endnote element. For example, as depicted in example interface 502B, the linking element 504B may include a reference element (e.g., an endnote element) indicating the location of the bibliographic information 506B that is descriptive of the linkable entity. To follow the depicted example of interface 502B, the footnote element 504B can indicate that the bibliographic information 506B is located at endnote 14.

It should be noted that the bibliographic information 506 can be generated according to various citation formats selected by the user. For example, the user may indicate (e.g., via a settings menu associated with the first and/or second application) that bibliographic information 506 should be generated according to Modern Language Association (MLA) format. Accordingly, information can be extracted from the linkable entity(s), and the information can be used to generate the bibliographic information 506 according to the selected format.

In some embodiments, the linkable element 504 includes a hyperlink. The hyperlink can include link(s) to the linkable entity(s) and textual content descriptive of the linkable entity(s). For example, as depicted in example interface 502C, the linking element 504C may include a hyperlink to the linkable entity previously selected by the user. In some embodiments, the hyperlink may include additional textual content descriptive of the linkable entity. For example, if the persistent insertion point is located at the last location of an input element, the hyperlink may include automatically generated textual content descriptive of the linkable entity. The textual content may be extracted, or otherwise determined, from the linkable entity (e.g., via metadata associated with the linkable entity, textual content included within the linkable entity, etc.). Alternatively, as depicted in example interface 502C, if the persistent insertion point is located at a portion of textual content selected by the user, the selected textual content may be utilized as the textual content of the hyperlink.

In some embodiments, the linkable entity may be or otherwise include a document, and the link to the linkable entity included in the hyperlink may link to a location within the document. For example, the linkable entity may be a web document that includes a number of pages. The link may link to a specific page such that interaction with the hyperlink opens the document at the linked page.

In some embodiments, after generating the linking element, the interface for the first application may be automatically provided to the user. Alternatively, in some embodiments, the interface for the first application may not be automatically provided, and the user instead can make a decision to navigate back to the first application. In some embodiments, whether or not the interface for the first application is automatically provided to the user may be controlled by a user-configurable setting.

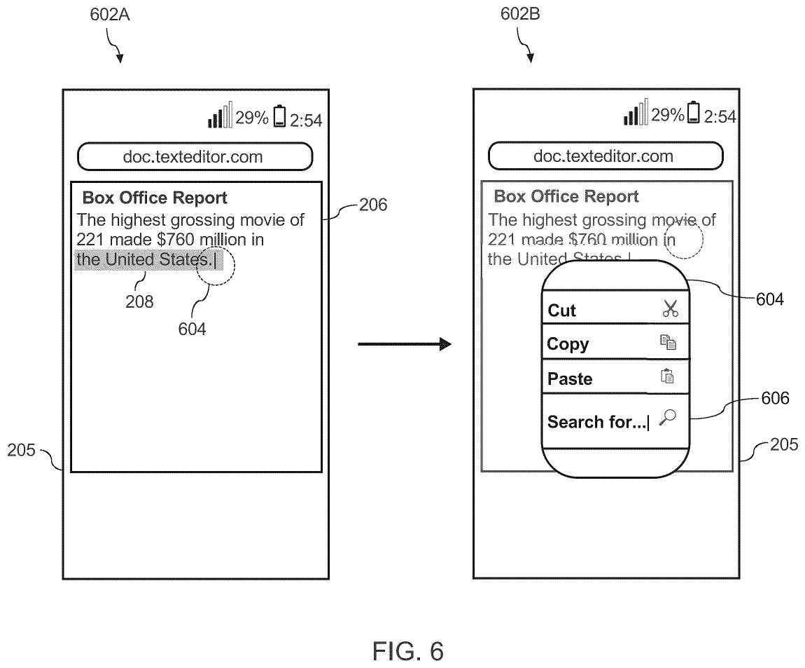

FIG. 6 illustrates interfaces 602A and 602B of a first application 604 according to some other embodiments of the present disclosure. Specifically, example interface 602A includes first application 204, user computing device 205, input field 206 and persistent insertion point 208 as described with regards to FIG. 2. However, as illustrated, the interface 602A of application 204 can receive a navigational input 604. The navigational input 604 may indicate an instruction to navigate from the first application 204 to a second application, and may include multiple inputs as described with regards to FIG. 4. For example, the navigational input 604 may include an input to open an action menu 604 that includes selectable action elements. In some embodiments, as illustrated in example interface 602B, this action menu 604 may include a selectable search element 606 that allows the user to input a search query to a second application. By inputting the search query to the selectable search element, the navigation input 604 may be completed so that the user navigates to the second application.

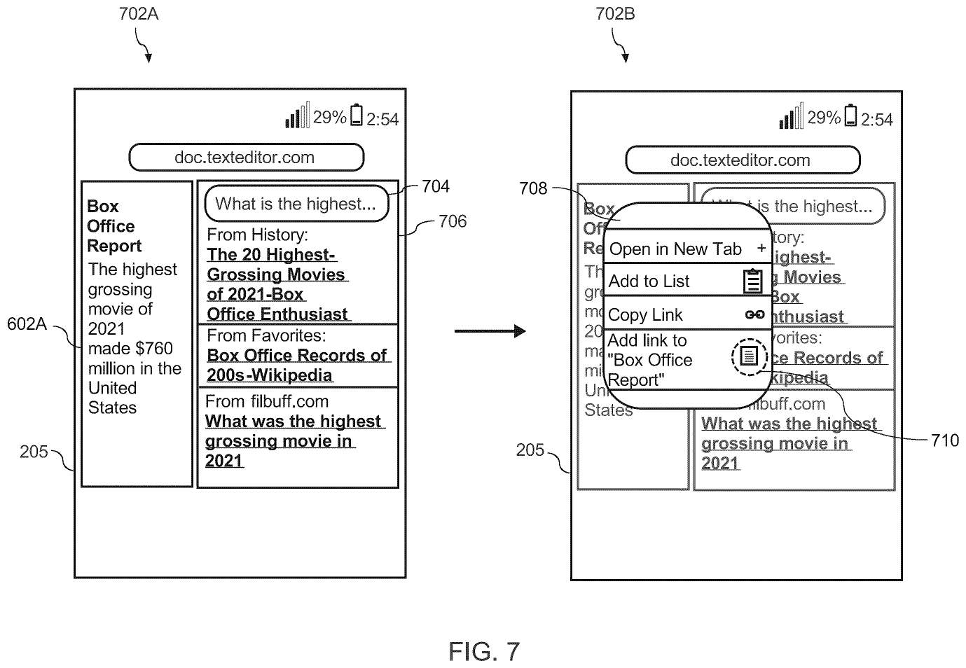

FIG. 7 illustrates interfaces 702A and 702B of a second application 704 according to some other embodiments of the present disclosure. Specifically, once the user enters the query to the selectable search element 606 as described with regards to FIG. 6, an interface 702A of the second application 704 can be provided to the user concurrently with a modified interface 602A for the first application 604. As depicted, in some embodiments the second application 704 may be a search engine application.

The second application 704 can retrieve a number of linkable entities 706 (e.g., search results) in response to the user's query. As depicted in example interface 702B, an action menu 708 can be provided to the user, and at least one of the linkable entities 706 can be selected via a second input from the user 710 as described with regards to FIGS. 3 and 4. In such fashion, the interface of the second application 704 can be displayed concurrently with the interface 602A of the first application 604, therefore allowing the user to generate a linking element within the input field of the interface 602A without any additional navigational inputs, further increasing the speed and efficiency of the interface to the user.

### Example Methods

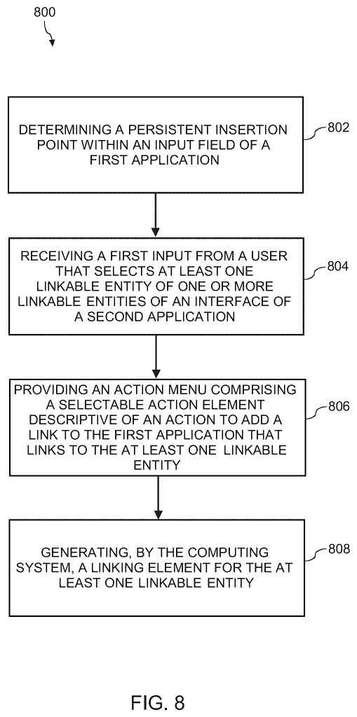

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system (e.g., user computing device 102 of FIG. 1, etc.) determines a persistent insertion point. Specifically, the computing system determines a persistent insertion point within an input field of a first application. In some embodiments, the persistent insertion point comprises a last location of an input element within the input field of the first application. In some embodiments, the input element comprises an input cursor and the input field of the first application comprises a textual input field. In some embodiments, the persistent insertion point includes a selected portion of the input field. In some embodiments, the input field includes a textual input field comprising textual content, and the persistent insertion point includes a selected portion of the textual content.

In some embodiments, prior to step 802, the computing system receives a navigation input indicative of an instruction to navigate from the first application to the second application. Responsive to the navigation input the computing system can provide the interface of the second application to the user. In some embodiments, the second application includes a search engine application, the navigation input includes a search query from the user, and the interface of the second application is overlaid upon the interface of the first application.

At 804, the computing system receives a first input from a user. Specifically, the computing system receives a first input from a user that selects at least one linkable entity of one or more linkable entities of an interface of a second application. The first input can indicate an instruction to provide an action menu associated with the at least one linkable entity. In some embodiments, the linking element comprises a hyperlink comprising textual content and a link to the linkable entity, and the textual content is descriptive of the linkable entity.

In some embodiments, the linkable entity comprises a document, and the link to the linkable entity links to a location within the document. In some embodiments, the first application is executed within a first instance or tab of a web browser, and the second application is executed within a second instance or tab of the web browser. Additionally, or alternatively, in some embodiments the first application includes a content editor application and the second application includes a search engine application.

In some embodiments, the one or more linkable entities comprise one or more respective search results responsive to the search query from the user.

At 806, the computing system provides an action menu including a selectable action element that corresponds to an action. Specifically, the computing system provides an action menu comprising a selectable action element corresponding to an action and that describes an action to add a link to the first application that links to the at least one linkable entities.

At 808, the computing system generates a linking element. Specifically, responsive to a second input from the user that selects the selectable action element, the computing system generates a linking element for the at least one linkable entity. The linking element can be located at the persistent insertion point within the input field of the first application. In some embodiments, the computing system can provide an interface for the first application that includes the input field of the first application. For example, the computing system, responsive to generating the linking element for the at least one linkable entity, can automatically provide the interface for the first application that comprises the input field of the first application.

In some embodiments, the linking element comprises a reference element indicative of a location of bibliographic information descriptive of the linkable entity. Generating the linking element for the at least one linkable entity includes generating the linking element and the bibliographic information descriptive of the linkable entity. The reference element can be located at the persistent insertion point within the input field, and wherein the bibliographic information is generated at a location different than the persistent insertion point.

In some embodiments, the reference element comprises a footnote element or an endnote element, and the bibliographic information respectively comprises a footnote or an endnote. Additionally, or alternatively, in some embodiments the linking element comprises a parenthetical citation. In some embodiments, the linkable entity includes multimedia content and/or textual content. The hyperlink can link to at least a subset of the linkable entity.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for optimizing interface efficiency via persistence across applications, comprising:
determining, by a computing system comprising one or more computing devices, a persistent insertion point within an input field of a first application;
receiving, by the computing system, a first input from a user that selects at least one linkable entity of one or more linkable entities of an interface of a second application, wherein the first input is indicative of an instruction to provide an action menu associated with the at least one linkable entity;
providing, by the computing system, an action menu comprising a selectable action element corresponding to an action, wherein the selectable action element is descriptive of an action to add a link to the first application that links to the at least one linkable entity; and
responsive to a second input from the user that selects the selectable action element, generating, by the computing system, a linking element for the at least one linkable entity, wherein the linking element is located at the persistent insertion point within the input field of the first application.

2. The method of claim 1, wherein the method further comprises providing, by the computing system, an interface for the first application that comprises the input field of the first application.

3. The method of claim 2, wherein providing the interface for the first application comprises, responsive to generating the linking element for the at least one linkable entity, automatically providing, by the computing system, the interface for the first application that comprises the input field of the first application.

4. The method of claim 1, wherein the persistent insertion point comprises a last location of an input element within the input field of the first application.

5. The method of claim 4, wherein the input element comprises an input cursor and the input field of the first application comprises a textual input field.

6. The method of claim 5, wherein the linking element comprises a hyperlink comprising textual content and a link to the linkable entity, wherein the textual content is descriptive of the linkable entity.

7. The method of claim 6, wherein the linkable entity comprises a document; and
wherein the link to the linkable entity links to a location within the document.

8. The method of claim 5, wherein the linking element comprises a reference element indicative of a location of bibliographic information descriptive of the linkable entity; and
wherein generating the linking element for the at least one linkable entity comprises generating, by the computing system, the linking element and the bibliographic information descriptive of the linkable entity, wherein the reference element is located at the persistent insertion point within the input field, and wherein the bibliographic information is generated at a location different than the persistent insertion point.

9. The method of claim 8, wherein:
the reference element comprises a footnote element or an endnote element; and
the bibliographic information respectively comprises a footnote or an endnote.

10. The method of claim 5, wherein the linking element comprises a parenthetical citation.

11. The method of claim 5, wherein the linkable entity comprises:
multimedia content; or
textual content; and
wherein the hyperlink links to at least a subset of the linkable entity.

12. The method of claim 1, wherein the persistent insertion point comprises a selected portion of the input field.

13. The method of claim 1, wherein the input field comprises a textual input field comprising textual content, and wherein the persistent insertion point comprises a selected portion of the textual content.

14. The method of claim 1, wherein the first application is executed within a first instance or tab of a web browser, and wherein the second application is executed within a second instance or tab of the web browser.

15. The method of claim 14, wherein the first application comprises a content editor application, and wherein the second application comprises a search engine application.

16. The method of claim 15, wherein, prior to receiving the first input from the user, the method comprises:
receiving, by the computing system, a navigation input indicative of an instruction to navigate from the first application to the second application; and
responsive to the navigation input, providing, by the computing system, the interface of the second application to the user.

17. The method of claim 16, wherein:
the second application comprises a search engine application;
the navigation input comprises a search query from the user; and
the interface of the second application is overlaid upon the interface of the first application.

18. The method of claim 17, wherein the one or more linkable entities comprise one or more respective search results responsive to the search query from the user.

19. A computing system for optimizing interface efficiency via persistence across applications, comprising:
one or more processors;
one or more non-transitory computer-readable media that store instructions that, when executed by the one or more processors, cause the computing system to perform operations, the operations comprising:
determining a persistent insertion point within an input field of a first application;
receiving a first input from a user that selects at least one linkable entity of one or more linkable entities of an interface of a second application, wherein the first input is indicative of an instruction to provide an action menu associated with the at least one linkable entity;
providing an action menu comprising a selectable action element corresponding to an action, wherein the selectable action element is descriptive of an action to add a link to the first application that links to the at least one linkable entity; and
responsive to a second input from the user that selects the selectable action element, generating a linking element for the at least one linkable entity, wherein the linking element is located at the persistent insertion point within the input field of the first application.

20-21. (canceled)

22. One or more non-transitory computer-readable media that store instructions that, when executed by one or more processors, cause a computing system to perform operations, the operations comprising:
determining a persistent insertion point within an input field of a first application;
receiving a first input from a user that selects at least one linkable entity of one or more linkable entities of an interface of a second application, wherein the first input is indicative of an instruction to provide an action menu associated with the at least one linkable entity;
providing an action menu comprising a selectable action element corresponding to an action, wherein the selectable action element is descriptive of an action to add a link to the first application that links to the at least one linkable entity; and
responsive to a second input from the user that selects the selectable action element, generating a linking element for the at least one linkable entity, wherein the linking element is located at the persistent insertion point within the input field of the first application.
